(19) United States
(12) Patent Application Publication
(10) Pub. No.: US 2003/0180206 A1
(43) Pub. Date: Sep. 25, 2003

(54) Process for manufacturing boron nitride fibres and resulting fibres

(75) Inventors: Philippe Miele, Lyon (FR); Berangere Toury, Nogent Sur Marne (FR); David Cornu, Villeurbanne (FR); Samuel Bernard, Prisches (FR); Marie-Paule Berthet, Lyon (FR); Loic Rousseau, St. Aubin de Medoc (FR); Guy Beauhaire, Bougival (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: EADS LAUNCH VEHICLES, PARIS CEDEX 16 (FR)

(21) Appl. No.: 10/346,121

(22) Filed: Jan. 17, 2003

(30) Foreign Application Priority Data
Jan. 22, 2002 (FR) 02 00757

(51) Int. Cl. C01B 21/064

(52) U.S. Cl. 423/290

(57) ABSTRACT

The present invention concerns high performance boron nitride fibres and a process for manufacturing said fibres.

The present invention uses a borylborazine precursor of the following formula (I):

[(NHR)₂B(NR)]₃B₃N₃H₃ (I)

in which R represents a hydrogen atom or an alkyl, cycloalkyl or aryl group, said group comprising from 1 to 30 carbon atoms.

### TECHNICAL FIELD

The aim of the present invention is a process for manufacturing boron nitride fibres, in particular continuous boron nitride fibres with good mechanical properties.

More precisely, the invention concerns the production of boron nitride fibres from a precursor polymer that is formed by spinning to form polymer fibres that are then subjected to a ceramisation in order to transform them into boron nitride fibres.

Ceramic boron nitride fibres are very useful for manufacturing composite materials with good oxidation resistance, thermal resistance and electrical insulation properties.

For composite materials, particularly ceramic matrix materials, it is preferable to have continuous fibres to improve the fracture resistance of the ceramic.

Moreover, it is necessary to use flexible fibres having high tensile strengths.

### STATE OF THE PRIOR ART

The references in square brackets [ ] refer to the appended list of references.

There are numerous processes for manufacturing boron nitride, as described by R. T. PAINE et al, [1]. Amongst the methods described in this document, one finds in particular processes using precursor polymers formed from inorganic boron compounds such as borazenes.

One way of obtaining such precursor polymers has been described by C. K. Narula et al [2]. It consists in reacting trichloroborazine or 2-(dimethylamino)-4,6-dichloroborazine with hexamethyl disilazane in solution in dichloromethane at ambient temperature. In the case where one uses 2-(dimethylamino)-4,6-dichloroborazine, one favours the polymerisation in two points due to the presence of the NMe₂ group.

Another way of obtaining precursor polymers described in EP-A-O 342 673 [3], consists in reacting a B-tris (lower alkyl amino) borazine with an alkyl amine such as lauryl amine, thermally in bulk or in solution.

One may also obtain other precursor polymers by thermal polycondensation of trifunctional aminoborazines of formula [B(NR¹R²)—NR³—]₃ in which R¹, R² and R³, which are identical or different, represent hydrogen, an alkyl radical or an aryl radical, as described in FR-A-2 695 645 [4].

The polymers described above are well suited to obtaining powder or other forms of boron nitride but it is more difficult to prepare more complex forms, in particular fibres from such polymers.

Often, in fact, the drawing of the precursor polymer necessary for shaping the fibres is poor due to its statistical, cross-linked structure, which leads to little elongation, making proper control of the section of the fibre very hazardous. Further on in the process, this is reflected in the breaking of fibres or weak points, which lead to very poor ultimate mechanical properties.

Thus, as is indicated by T. Wideman et al [5], research has been carried out to find other precursor polymers that are better suited to obtaining boron nitride fibres. In this document, it is indicated that a precursor polymer that is spinnable in the melted state may be obtained by modifying polyborazylene by reaction with a dialkyl amine.

It therefore appears that numerous pathways have been considered for manufacturing boron nitride fibres, but without success.

The materials obtained according to the prior art are matrices or solid BN, but not continuous fibres of boron nitride of the good quality indispensable for the manufacture of ceramic composite materials with good mechanical performance.

The polymers used in the prior art for preparing BN fibres were always formed from cycles linked by direct bonds and/or by one —N— atom bridge type bonds. Said polymers are obtained from aminoborazines of general formula (NRR′)₃ B₃N₃R″₃. Due to their structure, said polymers are however difficult to spin.

At present, the highest performance fibres are obtained by thermal polycondensation of aminoborazines under a flow of inert gas. This technique uses high temperatures and the polymerisation rates are relatively slow.

### DESCRIPTION OF THE INVENTION

The precise aim of the present invention is to provide boron nitride fibres, continuous and weavable, of high purity, with high performance levels that are maintained under natural ageing, obtained from polyborylborazine type precursor polymers, with diameters suited for use in composite materials, as well as a process for manufacturing said fibres. A further aim of the present invention is to provide polymers with higher spinnability than the polymers described in the prior art.

The boron nitride fibres of the present invention are obtained by using a borylborazine precursor of the following formula (I):

[(NHR)₂B(NR)]₃B₃N₃H₃ (I)

in which R represents a hydrogen atom or an alkyl, cycloalkyl or aryl group, said group comprising from 1 to 30 carbon atoms.

According to the present invention, R may comprise, preferably, from 1 to 10 carbon atoms and even more preferably from 1 to 6 carbon atoms.

According to the invention, R may be selected for example from the group comprising methyl, ethyl, propyl, isopropyl, butyl, isobutyl, pentyl, isopentyl, hexyl or isohexyl.

The borylborazine precursors of formula (I) of the present invention make it possible to obtain polymers made up of cycles connected to each other by original N-B-N type three atom intercyclic bridges, the characteristics of which meet those described for the best precursor polymers for boron nitride fibres. Said structure provides great flexibility to the polymer, which may then be formed into the shape of a thread very easily.

Said precursors may be obtained for example in one step from trichloroborazine Cl₃B₃N₃H₃ and an aminoborane B (NHR)₃ in respective proportions of ⅓ in the presence of an excess of triethylamine Et₃N in relation to the number of moles of chlorine atoms. Said excess makes it possible to trap the hydrogen chloride formed in the form of solid trimethylamine chlorohydrate. After evaporation of the liquid phase, the precursor (I) may be recovered by evaporation of the solvent.

The considerable number of carbon atoms in the borylborazine precursors of formula (I) compared to the aminoborazines of the prior art could be seen as a disadvantage for the ceramisation yield, which is preferably as high as possible. However, the inventors have observed that, in an unexpected manner, it provides the polymer with good flexibility. Moreover, according to the invention, going from a precursor with few carbon atoms, such that R=CH₃, to a precursor with a higher number of carbon atoms, for example where R=iPr, advantageously makes it possible to better control the rate of polycondensation in order to obtain a polymer with a viscosity suited to spinning.

When R=iPr, the ceramic yield drops but the ceramic yield/suitability for spinning combination offers a good compromise, making it possible to obtain in fine boron nitride fibres with high mechanical performance.

By way of example of borylborazine precursors that may be used according to the present invention, one may cite the tri (isopropyl aminoboryl) borazine of formula (II) or the tri (methyl aminoboryl) borazine of formula (III) below:

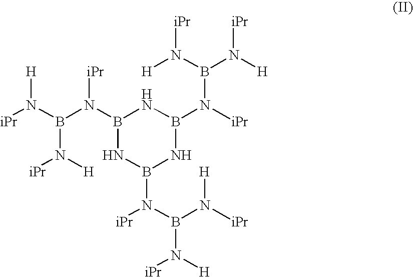

in which iPr is an isopropyl group.

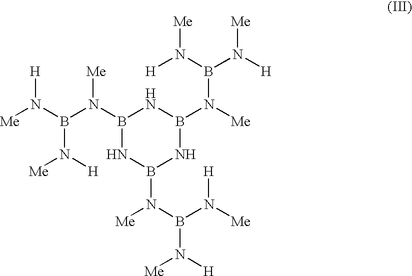

in which Me is a methyl group.

The boron nitride fibres of the present invention are advantageously obtained by the process of the present invention comprising the following steps:

a) thermal polycondensation, under a pressure below 10⁵ Pa, of a borylborazine precursor of formula (I) described above, in order to obtain a polymer,

b) spinning the polymer obtained in step a) in order to obtain fibres of said polymer, and

c) heat ceramisation treatment of the fibres obtained in step b) in order to obtain ceramic boron nitride fibres.

According to the invention, the thermal polycondensation step is carried but at a pressure less 10⁵ Pa, in other words reduced pressure. This advantageously makes it possible to eliminate the aminoborane co-produced in the polycondensation as and when it is produced. In fact, were this not the case, said aminoborane could lead to secondary polycondensation reactions and/or self-polymerisation that are harmful to the control of the polycondensation rate and the nature of the polymer. The pressure may be greater than or equal to 10 Pa.

Moreover, the fact that the process of the present invention is carried out under reduced pressure also makes it possible to recover the products arising from the polycondensation reaction very easily and thus to recycle them.

Finally, the use of a reduced pressure makes it possible to increase the rate of the polycondensation reaction and thus to reduce the time of this step.

The pressure may for example be from 10 to 10² Pa.

According to the invention, the thermal polycondensation step a) may advantageously be carried out at a temperature of 30 to 150° C., for example from 50 to 150° C.

According to the invention, it is possible to act on the final mechanical and structural properties of the boron nitride fibres by controlling the degree of polymerisation of the precursor polymer.

Thus, in an advantageous manner, according to the present invention, the polymerisation of the borylborazine is carried out in such a way that the polymerisation level of the precursor polymer, i.e. the number of moles of boron atoms released in the form of aminoborane B(NHR)₃ per mole of borylborazine, is greater than or equal to 1, preferably from 1 to 2 and even more preferably around 1.4.

By choosing the degree of polymerisation in this range, a precursor polymer with a glass transition temperature from 30 to 100° C., and preferably from 20 to 50° C., is obtained, which can be transformed by spinning and ceramisation into boron nitride fibres having the desired mechanical properties.

The degree of polymerisation may be adjusted by selecting the end of polymerisation temperature and the length of polymerisation.

Generally, the end of polymerisation temperature is from 180 to 200° C., and preferably from 130 to 150° C.

The length of polymerisation is a function of the weight of the monomer to be polycondensed.

According to the invention, the spinning step is generally carried out under a controlled atmosphere and it has been observed that it is preferable to maintain the relative humidity level of this atmosphere at a value below 10% and preferably below 2%.

The polymer may be extruded through a die of 50 to 500 μm and more particularly 100 to 200 μm, which is surmounted by a filter and a cutting element. The drawing of the polymer thread is achieved by means of a refractory spool with a diameter of between 50 and 200 mm, and more precisely from 50 to 100 mm. Said spool may, for example, be in graphite.

In order to obtain good results, the spinning is preferably carried out at a spinning temperature Tf such that 70° C.≦Tf−Tg≦155° C., and preferably 80° C.≦Tf−Tg≦110° C. Spinning at temperatures lower than 155° C. is possible thanks to the precursors of the present invention. Tf may be lower than the end of polymerisation temperature.

According to the present invention, the ceramisation treatment may be carried out using the traditional methods generally used for the transformation of fibres from precursor polymers based on aminoborazines into boron nitride, by subjecting them to a heat treatment in the presence of ammonia, then nitrogen and, if appropriate, an inert gas such as argon.

According to the invention, a ceramic treatment suited to the type of polymer used according to the present invention, for example depending on whether R=Me or iPr, makes it possible to convert the polymeric threads into BN fibres. Due to their structure, the polymers resulting from the borylborazine precursors used for producing the boron nitride fibres according to the present invention have a glass transition temperature and thus a lower spinning temperature than that of products of the prior art.

Preferably, the ceramisation is carried out in two steps, by carrying out a first pre-ceramisation step with ammonia up to a temperature less than or equal to 1000° C., preferably 400 to 600° C. and even more preferably from 500 to 600° C., then by carrying out a ceramisation step under a nitrogen and/or noble gas atmosphere at higher temperatures, for example from 1400 to 2200° C., in one or several successive operations.

For these treatments, one can use a heating unit that makes it possible to increase the temperature at a rate of 5 to 1000° C./h, and preferably from 15 to 700° C./h.

According to the invention, the high performance boron nitride fibre obtained from the borylborazines is a continuous hexagonal boron nitride fibre that can be woven, in the form of monofilament or a roving of filaments, and the filament(s) have an average tensile strength σ_{R} of at least 700 MPa, and preferably from 900 to 2000 MPa, an average Young's modulus E of 50 to 250 GPa, and preferably from 50 to 200 GPa, and an average elongation at break distribution ε_{R} of 0.2 to 2%, and preferably from 0.2 to 1%.

It should be pointed out that the median tensile strength σ_{R} is determined on around fifty filaments with a test length of 1 cm. The break tests are analysed by the Weibull model, where the median tensile strengths are determined for a break probability equal to 0.63. One defines an average value for the average elongation at break (ε_{R}) distribution and from this value, one calculates the median value of the tensile strength (σ_{R}) distribution at a survival probability of 037. One can then deduce the Young's modulus or elasticity E from this.

According to the invention, the diameter of the filament(s) making up the fibre is preferably from 4 to 25 μm.

The boron nitride forming the fibres is hexagonal boron nitride. This structure corresponds to a stacking of hexagonal planes of BN. This type of structure is described, for example, in patent application FR-A-2 806 422.

According to the invention, the fibre advantageously has an impurity level of less than 1%, in particular it contains less than 0.1% by weight in total of elements of atomic weight greater than 11, and has a specific gravity greater than or equal to 1.8 g/cm².

Moreover, the fibre maintains its high performance under natural ageing. In fact, under accelerated ageing at 65° C., in an atmosphere with a relative humidity of 75%, no measurable reduction in the mechanical properties after two months is observed.

The fibres of the present invention have excellent spinnability and, as a result, allow easy spinning, whereas with the polymers of the prior art this step is very delicate.

The fibres obtained according to the present invention are high performance fibres. The precursor polymer of the fibres of the present invention provides an ideal compromise between spinnability and ceramic yield, in other words it contains both long linear chains and cycles to limit reverse reactions.

Moreover, the process for synthesising the polymers and fibres of the present invention allows time and energy savings that are important for industrial production.

The industrial applications of the present invention are numerous, amongst which one may cite by way of example the manufacture of coatings that protect against oxidation, boron nitride foams, BN/C or BN/BN composite materials, heat sinks for the microelectronics field, manufacturing thermo-structural parts or antenna radomes, etc

Other advantages and characteristics of the present invention will become clear to those skilled in the art through the examples below, given by way of illustration and in nowise limitative.

### EXAMPLES

### Example 1

Synthesis of Borylborazine Precursors

In this example, the inventors describe the synthesis of two borylborazine precursors (monomers) that are tri (isopropyl aminoboryl) borazine (formula (II)) and the tri (methyl aminoboryl) borazine (formula (III)). Compared to the precursor (II), the precursor (III) contains little carbon, which makes it possible to increase its ceramic yield.

A) Synthesis of the Precursor (II)

Said precursor was obtained by reacting, in toluene, a mixture of three equivalents of tris (isopropylamino) borane with one equivalent of trichloroborazine. The synthesis was carried out in the presence of triethylamine, used to precipitate the hydrogen chloride liberated by the reaction in the form of triethylamine chlorohydrate.

The trichloroborazine was obtained by reacting boron trichloride (BCl₃) with ammonium chloride (NH₄Cl). The tris (isopropylamino) borane was obtained by reacting boron trichloride (BCl₃) with a large excess (greater than 6 times) of primary isopropylamine (NH₂iPr).

The tris (isopropylamino) borane was introduced into the solution of trichloroborazine in the presence of triethylamine in a reactor under an inert atmosphere (argon), and the mixture was subjected to a mechanical type agitation.

After the addition at −10° C., the reaction mixture was raised to ambient temperature and left under agitation for 24 hours.

The solution was then filtered under argon. On one hand, the triethylamine chlorohydrate residue was recovered and on the other hand the filtrate, which was evaporated under vacuum. A yellow, viscous liquid was recovered containing around 10% by weight of solvent.

At the end of the thermal polycondensation, the aminoborane released was determined by differential weighing between the polymer and the initial dry monomer, taking account of the proportion of toluene present at the start.

The reaction diagram below summarises the chemical reactions involved.

The resulting polymer was identified as a polyborylborazine with a glass transition temperature Tg, measured by differential scanning calorimeter (DSC), of 60° C. After heat treatment up to 1000° C., said polymer had a weight loss of 64.3%.

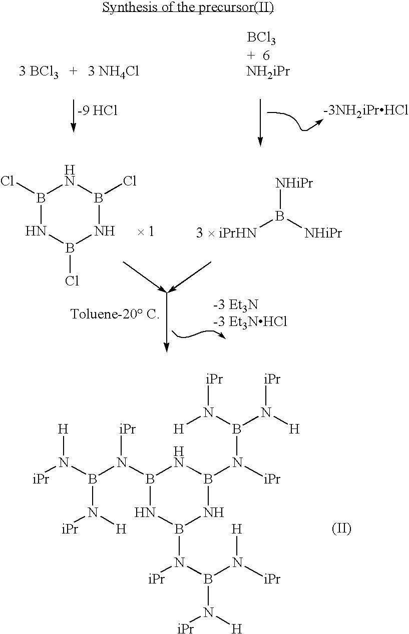

B) Synthesis of the Precursor (III)

The same procedure was used for the synthesis of the precursor (III), but replacing the tris (isopropylamino) borane with tris (methylamino) borane.

The resulting polymer was identified as a polyborylborazine with a glass transition temperature Tg, measured by differential scanning calorimeter (DSC), of 50° C. After heat treatment up to 1000° C., said polymer had a weight loss of 52.8%.

In the synthesis of the precursor (II) and the precursor (III), all of the intermediate and final products were characterised by multi-nucleus NMR, and the spectra had in fact the expected product signals.

### Example 2

Synthesis of the Precursor (II) Characteristics of the Resulting Polymer

The polycondensation of the precursor (II) obtained in the manner described in example 1 led to the formation of a polymer and the liberation of B (NHiPr)₃. This species could lead to secondary reactions and it is therefore important to carry out the increase in temperature under vacuum in order to remove the aminoborane as it is formed.

Two polycondensation mechanisms were envisaged. Said mechanisms are shown schematically below.

The first mechanism α leads to the formation of a three atom bridge between the borazine cycles. The second mechanism β allows the creation of an intercyclic bond. NMR analyses showed that the first mechanism α is in the majority, but that the mechanism β cannot be excluded. Moreover, the fact that the boryl groups are very hindered also goes in this sense. In fact, the cyclic protons are more difficult to reach by a boryl group.

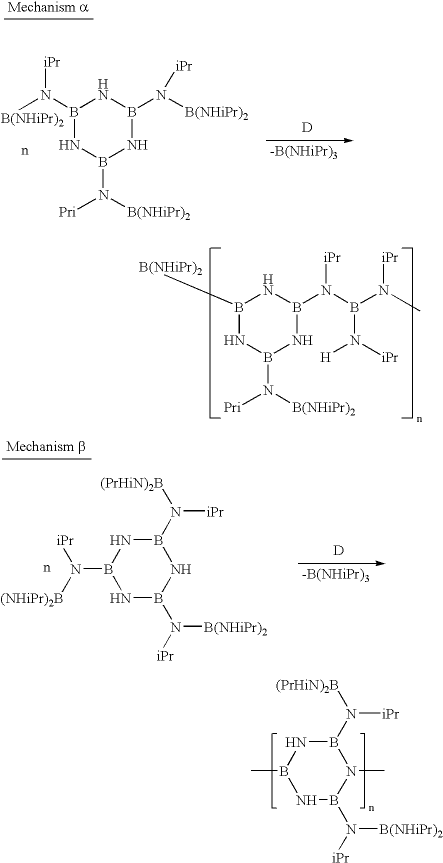

The polymerisation was carried out in a glass reactor under mechanical agitation, with one of the outputs of the reactor connected to a trap submersed in liquid air, itself connected to a vacuum (10 Pa). The temperature programme used is outlined below.

Monomer weight=11.9 g (of which 10% by weight was toluene)

$$\begin{matrix}Temperature programme = T = {20}^{°} C . ( 45 min . ) \\ T = {30}^{°} C . ( 30 min . ) \\ T = {70}^{°} C . ( 2 h 00 ) \\ T = {90}^{°} C . ( 1 h 00 ) \\ T = {100}^{°} C . ( 1 h 30 ) \\ T = {120}^{°} C . ( 2 h 15 ) \\ T = {140}^{°} C . ( 30 min . ) \\ T = {150}^{°} C . ( 1 h 30 )\end{matrix}$$

NB: the temperature was raised arbitrarily up to 120° C., then increased when the polymer became quite viscous.

Weight of the resulting dry monomer: 10.7 g (17.01 mmol)

Weight of polymer: 5.7 g

Weight of aminoborane liberated: 5 g (27.06 mmol).

The tris (isopropylamino) borane formed and recovered in the trap was analysed and characterised by ^{I}H NMR.

The growth rate of the polymer (nₐₘ/nₘₒₙₒ, where n is the number of moles) was 1.5. This corresponds to a very well advanced polymer.

The glass transition temperature of said polymer was around 60° C.

### Example 3

Polycondensation of the Precursor (III) and Characteristics of the Resulting Polymer

The polycondensation of the precursor (III) led, in the same way as the precursor (II), to the formation of a polymer and the liberation of B (NHMe)₂.

For the same reasons as described previously, the polycondensation was carried out under vacuum.

The characterisation by multi-nucleus NMR again indicated that the polymer was made up of cycles mainly connected by bridged bonds.

On the other hand, the control of the polycondensation was much more difficult in the second case, since the methyl aminoboryl groups have a very high reactivity. As a result, they react very quickly with each other and the polycondensation time therefore becomes very short.

After 45 minutes of gradual heating up to 130° C., the product became solid.

The polymer was in the form of a white, powdery solid with the following characteristics:

Weight of monomer: 6.5 g (of which 10% by weight was toluene)

Weight of dry monomer: 5.9 g (15.7 mmol)

Weight of polymer: 4.0 g

Weight of aminoborane liberated: 1.9 g (18.8 mmol).

The tris (isopropylamino) borane formed and recovered in the trap was analysed and characterised by ^{I}H NMR.

The growth rate of the polymer was 1.2.

The glass transition temperature of said polymer was around 50° C.

### Example 4

Spinning of the Polymer Derived From the Precursor (II) and Obtaining Boron Nitride (BN) Fibres

In the following examples, the fibres obtained were characterised by Raman spectrometry and chemically analysed by electronic spectroscopy (ESCA) as being hexagonal boron nitride fibres exempt of carbon. Their diameter, mechanical properties and structures were then determined.

The diameters were evaluated by the laser interferometry method using the Fraunhofer approximation. These are monofilaments that play the role of diffraction slits. The technique consists in measuring the distance between two consecutive interference bands, knowing the wavelength of the laser and the distance between the monofilament and the measuring screen.

The mechanical properties were determined by means of a microtraction machine. Frames on cardboard were arranged in the jaws in such a manner that the test corresponded to the traction of the monofilament. A traction force was applied to the monofilament. The tests were carried out on fifty or so monofilaments with a test length of 1 cm. The break tests on these filaments were carried out by the Weibull model where the tensile strengths were determined for a probability of break equal to 0.63. An average value for the elongation at break (ε_{R}) distribution was defined and from this value the median value of the elongation at break (ε_{R}) distribution at a survival probability of 0.63 was calculated. The Young's module or elasticity E could then be deduced from this.

The structural state of the filaments was determined by X-ray diffraction and Raman diffusion. The width at mid-height of the X-ray diffraction ray (002), which was situated at a 2θ value of 26.7650 for the hexagonal boron nitride, provided information on the crystallinity of the filament along the axis c.

The polymer was spun on a FILAMAT (trademark) of the PRODEMAT Company, with a die of 200 μm at a temperature of 151° C., while extruding at a speed of 0.85 to 1.4 mm/min under a force varying from 20 to 40 daN and winding it onto a graphite spool of 50 and 100 mm diameter at a drawing speed of 140 to 220 cm/s.

The pre-ceramisation treatment under ammonia up to at least 600° C. was then carried out in order to eliminate the methyl groups from the initial polymer, then under nitrogen up to 1800° C.

The pre-ceramisation and ceramisation heat treatments carried out were as follows:

Heat Treatment:

a) Pre-ceramisation: heating up to 600° C., at a rate of 25° C./h, under NH₃.

b) Ceramisation:

Heating from 600 to 1100° C., at a rate of 100° C./h, under N₂.

Maintaining at 1100° C., under N₂, for 90 minutes.

Cooling down to ambient temperature.

Heating up to 1400° C., at a rate of 600° C./h, under N₂.

Maintaining at 1400° C., under N₂, for 1 hour.

Heating from 1400 to 1600° C., at a rate of 600° C./h, under N₂.

Maintaining at 1600° C., under N₂, for 1 hour.

Heating from 1600 to 1800° C., at a rate of 600° C./h, under N₂.

Maintaining at 1800° C., under N₂, for 1 hour.

The treatment was carried out under mechanical strain by withdrawing the polymer on the refractory spool during the increase in temperature. The interest in continuing the treatment up to 1800° C. is to crystallise the boron nitride and position the BN crystals parallel to the axis of the fibre.

The fibres were then cooled to ambient temperature and they were characterised mechanically and structurally. They had a white appearance and were slightly slack around the spool.

The results of the pulling tests obtained on the different samples produced are summarised in Table 1 below.

In this table, V represents the rate of spooling, Φ the diameter of the fibres, σ_{R} the tensile strength and E the elasticity module.

The considerable reduction in the diameter of the fibres when one goes from the polymeric thread to the ceramic material is due to the low ceramic yield of the polymer (around 27%).

Analyses by X-ray diffraction and Raman diffusion spectrometry confirmed that well crystallised boron nitrate had been obtained.

TABLE 1

| | 1 | 2 | 3 | 4 |
|---|---|---|---|---|
| Spool (mm) | 100 | 100 | 50 | 50 |
| V_{spooling} (cm/s) | 160 | 160 | 145 | 200 |
| Vₚₛᵢₜₒₙ (mm/min) | 0.85 | 0.85 | 0.8-1 | 1.2-1.4 |
| φₜₕ untreated | 28.4 | 28.4 | 29-32.4 | 30-32.6 |
| φ ceramised (μm) | 8.4 | 7.4 | 10.5 | 11.0 |
| σ_{R} (MPa) | 910 | 950 | 1130 | 910 |
| E (GPa) | 163 | 195 | 195 | 168 |

### Example 5

Spinning of the Polymer Derived From the Precursor (III) and Obtaining Boron Nitrided (BN) Fibres

The same method was used as in example 4.

The polymer was threaded on a FILAMAT (trademark) of the PRODEMAT Company, with a die of 200 μm on a spool of 100 mm.

Spinning temperature=138° C.

The thermal pre-ceramisation and ceramisation treatments carried out were as those described in the previous example.

The polymers of the present invention, produced from the two prepared precursors (II) and (III) are very much more suited to spinning than the polymers of the prior art.

For example, the values of the mechanical properties of the fibres produced in particular from the precursor (II) allow this product to be a product of choice for the production of BN fibres.

Whereas the aminoborazine fibres of the prior art have the disadvantages of a low ceramic yield and poor control of the growth rate, the present invention has numerous advantages compared to the prior art. Said advantages are, in particular, the following:

an N-B-N three atom type bridged structure corresponding to that of a precursor that is ideal for boron nitride fibres.

a lower polycondensation temperature and shorter polycondensation time.

a polycondensation under vacuum allowing the aminoborane to be recycled.

a lower spinning temperature.

### LIST OF REFERENCES

[1]: R. T. PAINE et al, Chem. Rev., 90, 1990, pp. 73-91.

[2]: C. K. NARULA et al, Chem. Mater., 2, 1990, pp. 384-389.

[3]: EP-A-0 342 673.

[4]: FR-A-2 695 645.

[5]: T. WIDEMAN et al, Chem. Mater., 10, 1998, pp. 412-421.

1. Use of a borylborazine precursor of following formula (I):
[(NHR)₂B(NR)]₃B₃N₃H₃ (I)
in which r represents a hydrogen atom or an alkyl, cycloalkyl or aryl group, said group comprising from 1 to 30 carbon atoms,
for the manufacture of boron nitride fibres:

2. Use according to claim 1, in which R is selected from the group consisting of methyl, ethyl, propyl, isopropyl, butyl, isobutyl, pentyl, isopentyl, hexyl or isohexyl.

3. Use according to claim 1, in which the borylborazine precursor is the tri (isopropyl aminoboryl) borazine of formula (II) or the tri (methyl aminoboryl) borazine of formula (III) below: 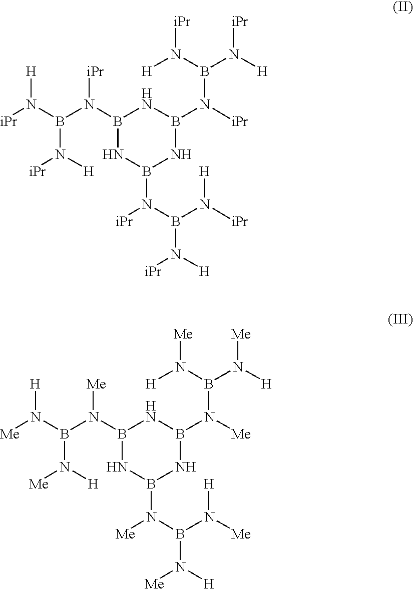
where iPr is an isopropyl group and Me is a methyl group.

4. Process for manufacturing boron nitride fibres comprising the following steps:
a) thermal polycondensation, at a pressure below 10⁵ Pa, of a borylborazine precursor of following formula (I):
[(NHR)₂B(NR)]₃B₃N₃H₃ (I)
in which R represents a hydrogen atom or an alkyl, cycloalkyl or aryl group, said group comprising from 1 to 30 carbon atoms, to obtain a polymer.
b) spinning the polymer obtained in step a) in order to obtain fibres of said polymer, and
c) heat ceramisation treatment of the fibres obtained in step b) in order to obtain ceramic boron nitride fibres.

5. Process according to claim 4, in which R is selected from the group consisting of methyl, ethyl, propyl, isopropyl, butyl, isobutyl, pentyl, isopentyl, hexyl or isohexyl.

6. Process according to claim 4, in which the thermal polycondensation step a) is carried out at a pressure greater than or equal to 10 Pa.

7. Process according to claim 4, 5 or 6, in which the thermal polycondensation step a) is carried out at a temperature from 30 to 150° C.

8. Process according to claim 4, in which the polymerisation rate is greater than 1.

9. Process according to claim 4, in which the polymerisation rate is from 1 to 2.

10. Process according to claim 4, in which the spinning is carried out at a spinning temperature Tf such that 70° C.≦Tf−Tg≦150° C., where Tf is the spinning temperature and Tg is the glass transition temperature of the polymer.

11. Process according to claim 10, in which the spinning temperature Tf is lower than the end of polymerisation temperature.

12. Process according to claim 4, in which the borylborazine precursor is the tri (isopropyl aminoboryl) borazine of formula (II) or the tri (methyl aminoboryl) borazine of formula (III) below: 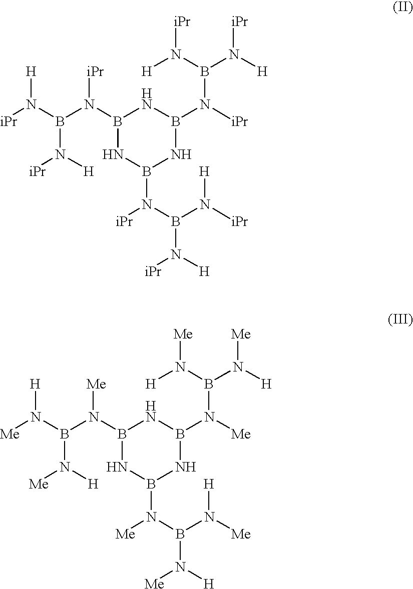
where iPr is an isopropyl group and Me is a methyl group

13. Process according to claim 4, in which the spinning is carried out in an atmosphere having a humidity level below 10% and preferably below 2%.

14. Process according to claim 4, in which the ceramisation step c) is carried out in two stages, by carrying out a first pre-ceramisation stage with ammonia up to a temperature less than or equal to 1000° C., then carrying out a second stage of ceramisation under a nitrogen and/or noble gas atmosphere at higher temperatures, particularly from 1400 to 2200° C., in one or several successive operations.

15. Boron nitride fibre obtained by a process according to any of claims 4 to 14.

16. Use of a process for manufacturing boron nitride fibres according to any of claims 4 to 14 for the manufacture of coatings that protect against oxidation, boron nitride foams, BN/C or BN/BN composite materials or heat sinks in the microelectronics field.

17. Use of boron nitride fibres according to claim 15, for the manufacture of coatings that protect against oxidation, boron nitride foams, BN/C or BN/BN composite materials or heat sinks in the microelectronics field.
